(19) United States
(12) Patent Application Publication
(10) Pub. No.: US 2015/0047139 A1
(43) Pub. Date: Feb. 19, 2015

(54) MANUAL DEVICE FOR CLEANING SURFACES, WITH INTEGRATED SPRAYING UNIT

(71) Applicant: Joker AG, Kerzers (CH)

(72) Inventor: Meinrad Flury, Kerzers (CH)

(21) Appl. No.: 14/383,484

(22) PCT Filed: Feb. 20, 2013
(86) PCT No.: PCT/EP2013/053335

§ 371 Date: Sep. 5, 2014

(30) Foreign Application Priority Data
Mar. 7, 2012 (CH) 00315/12

(51) Int. Cl. A47L 13/26; G02B 27/20; G06F 3/0354; A47L 13/16

(52) U.S. Cl. CPC A47L 13/26; A47L 13/16; G02B 27/20; G06F 3/03545
USPC 15/118

(57) ABSTRACT

A manual device for cleaning surfaces that can be operated with one hand has an integrated spraying unit, a reservoir for a cleaning fluid that can be sprayed using the spraying device, and a cleaning element that is suitable for wiping the surfaces to be cleaned. The manual device has a pen-like or flat rectangular shape, and the cleaning element is a hydrophilic microfibre cloth (4), comprising a flat cleaning surface, which is connected to the manual device and arranged longitudinally thereupon. The manual device is also advantageously multi-functional and has, in addition to its cleaning function, at least one additional function in the form of a pen tip (5) for operating temperature-sensitive display devices and/or a laser diode (6) for use as a laser pointer.

The invention relates to a manual device for cleaning surfaces which has an integrated spraying unit according to the patent claim 1.

If smooth surfaces such as, for example, glass windows or eyeglass lenses, are very dirty, they are traditionally cleaned in a manner that first a suitable cleaning fluid is sprayed thereon and subsequently, the dissolved dirt is wiped off and cleaned up using a soft and absorbent material. However, this method, which in principle is well established, has the disadvantage that two different and separate articles have to be used for this. More recent methods preferably also use so-called microfiber cloths which, in particular in the case of relatively little soiling, even allow to completely avoid the use of a liquid cleaning agent. In some cases, of course, the surfaces of certain articles still will benefit from the additional use of a liquid cleaning agent, in particular if it also has a maintaining and protecting effect that is tailored to the surface to be cleaned.

In the case of flat screens and in particular in the case of today's almost omnipresent touch screens for smart phones etc., there is of course a great need for cleaning since in particular the latter get dirty particularly fast due to perspiration residues and other dirt from the fingers of the users.

In the case of touch screens it is known that touch sensitivity can be generated with different technical means. For example, there are resistive, capacitive as well as different other types of touch screens. Due to the variety of the functional principles used, the touch screens have different layer structures and mostly also use different materials for the surfaces that are exposed to the tactile contact. Correct and appropriate maintenance for the touch is of course of particular importance.

Today's probably most commonly used touch screens are of the resistive type. They are generally regarded as relatively insensitive to dust, humidity, water drops and also to the most common chemicals in cleaning agents; however, in most cases, they a scratch-sensitive.

Resistive touch screens are often also preferred because they can normally be operated with fingers, styluses but also with gloves.

Cleaning recommendations for touch screens usually suggest that cleaning agents with ingredients such as alcohol or ammoniac and in particular also abrasive additives should not be used. Ideally, a cleaning agent for flat screens and touch screens should of course be usable for as many types and materials as possible, but at least for the aforementioned frequently used touch screens of the resistive type. However, suitable cleaning agents are known per se.

Overall, it can be stated that there is clearly an increased demand with regard to suitable and also easily transportable cleaning devices. There are already cleaning/application sets for touch screen and LCD displays that can be carried in containers or bags. However, these sets normally comprise separate agents for the respective individual function, thus, e.g., a cleaning agent, a microfiber cleaning cloth and the actual stylus.

Another prior art which, however, lies in a somewhat different field of use, is shown in US-2005/0063764. This publication shows a manual device for cleaning surfaces using an integrated spraying unit. It is a combination of a brush or a brush-like device with a spray can, wherein this manual device is specifically designed for hair care. However, it can of course also be used for the care of other articles such as, for example, fur surfaces. Here, the brush-like device can comprise detachable wipe sheets or the like, and the wipe sheets can serve for feeding active ingredients to the hair or for removing substances while the brush-like device runs through or over the hair. In particular, the wipe sheets can also be pretreated with cleaning agents and they can be used for removing dirt particles, hair and dandruff.

However, the device of US-2005/0063764 is obviously neither very suitable nor specifically designed for the purpose of cleaning smooth and flat surfaces. Moreover, the device requires relatively complicated handling when in use because the construction requires that for the functions “spray” and “brush”, the device must be held by hand in exactly opposite positions.

Furthermore, a case for writing, drawing or painting utensils having additional functional elements is known from DE-20300992-U1, which case has a cleaning element in the form of a wipe sheet that is fixedly attached on one side. This device, which can be operated with one hand, is provided specifically for cleaning smooth and flat surfaces such as whiteboards or flipcharts; however, there is no spraying unit.

Finally, U.S. Pat. No. 5,924,153 describes a device for removing dust, which is suitable for cleaning screens. This too is a brush-like device that can be operated with one hand and that is provided with a synthetic fleece material on the active surface or wiping surface. However, it also lacks of an integrated spraying unit.

Finally, US-2003/0143016, WO-2006/121802 and US-2011/0052307 also show combination devices which comprise an integrated spraying unit as well as means for wiping. In the case of US-2003/0143016, the latter is an extendable towel and in the case of WO-2006/121802 it is a fold-out brush. In the case of US-2011/0052307, the means for wiping is either a removable rolled-up cloth, a removable wiping element or a wiping element that can be captively secured on the spraying unit. However, none of these disclosures shows a pen-like device, and the provided applications are limited to cleaning functions.

It is therefore an object to provide a manual device for cleaning surfaces that has a spraying unit and is versatile and can be operated with one hand, which is suitable specifically for smooth and flat surfaces.

Another object is that the manual device for cleaning surfaces, which has an integrated spraying unit, shall be suitable in particular for cleaning electronic devices having touch-sensitive screens, thus so-called touch screens.

These objects are achieved by the feature combination of the patent claim 1.

The solution is that a generic and versatile manual device that can be operated with one hand and that has an integrated spraying unit and cleaning element is designed such that is has a pen-like or flat rectangular shape, and that the cleaning element is a hydrophilic microfiber cloth comprising a flat cleaning surface, which microfiber cloth is connected to the manual device and is arranged thereon in the longitudinal direction.

The pen-like or the flat rectangular shape allows that the device can be easily transported because it can easily be accommodated in a space-saving manner in jacket pockets or coat pockets. This applies even if it is accommodated in a suitable shape-matching protective case. The pen-like or flat rectangular shape also makes it suitable for additional functions which, of course, are specifically helpful in connection with devices having touch screens and in particular in the case of small devices such as smartphones. One of these additional functions is a pen tip (stylus) for operating touch-sensitive display devices (touch screens). Another additional function is, for example, the integration of a laser pointer for use during presentations and lectures.

Advantageously, the flat cleaning surface on the longitudinal side of the device has an elongated rectangular shape. This enables that rectangular, smooth and flat surfaces can be cleaned completely and thoroughly even in the outermost corners.

Furthermore, in a manual device according to the invention that has a pen-like shape, the spray head of the spraying unit, for the purpose of easy and reliable closing, can be attached at an end of the pen-like shape to be pivotable about a longitudinal axis. In this manner it is possible to combine an elegant design with a functional design.

If a multifunctional manual device suitable for presentations is envisaged, the pen tip (stylus) for operating touch-sensitive display devices (touch screens) and the laser pointer of a manual device having a pen-like shape can advantageously be arranged at opposite ends of the manual device. This too can be very easily combined with an elegant and functional design. Moreover, for easy operation of the laser pointer, a touch-sensitive contact surface for triggering the laser pointer function can be provided in a lateral region of the pen.

If a manual device according to the invention having a pen-like shape with stylus function is to be suitable mainly for use with today's widely used touch screens of the resistive type, the pen tip (stylus point) for operating touch-sensitive display devices (touch screens) can be provided with an electrically conductive pigmentation having an electrical resistance >200Ω.

As mentioned, the actual cleaning element, however, is a microfiber cloth comprising a flat cleaning surface, which microfiber cloth is connected to the manual device and is arranged thereon in the longitudinal direction (on a lateral surface). The hydrophility of the microfiber cloth is of particular importance for screens of electronic devices because in this manner, excess cleaning fluid can be removed again in a fast and reliable manner from the surface to be cleaned. This is important, for example, if possible leakages of the device to be cleaned could result in that the electronics located inside the device get damaged by the penetrating excess cleaning fluid or by moisture. For improving the hydrophilic properties, the microfiber cloth therefore advantageously contains a hydrophilic substance with a boron content in order to absorb or cross-link a larger portion of cleaning fluid or water. Of course, for absorbing or cross-linking the cleaning fluid, other substances, for example substances having a silver ion content or a nanoparticle content, can also be used. Furthermore, the microfiber cloth can also have a multi-layered structure.

The cleaning fluid used is advantageously free of alcohol in order to protect the touch-sensitive screens; however, it can also contain fragrances or disinfectants. For example, substances containing silver nitrate can be provided as disinfectants. Since in particular the screens of smartphones and tablet computers are a significant hygienic risk due to the frequent use and operability with bare fingers, regular cleaning and disinfection of these touch screens is of very high importance. Of course, this is also particularly beneficial to the health of the users, specifically if a touch screen device is used by a plurality of persons.

Furthermore, the cleaning device according to the invention is advantageously also configured in such a manner that the microfiber cloth can be easily replaced. The latter, thus easy replaceability, is of course also provided for the other consumables of the cleaning device, namely for a cartridge for the cleaning fluid, for possibly required batteries and for the actual stylus head (if there is one). Due to the last-mentioned property, thus the replaceability of the stylus head, the multi-functionality of the cleaning device can also be optimally adapted to other touch screen types, if needed.

For further improvement of the serviceability of the cleaning device according to the invention, holding magnets can also be installed so that the device can be captively secured on the metallic housing of a tablet computer, for example. Of course, the manual device can also be provided with another holding device by means of which it can be secured on another article or on a piece of clothing. Thus, it can be provided with loops, velcro-type elements or clips, for example.

Furthermore, the manual device can be provided to be used with a base into which the manual device can be placed or plugged when not in use in such a manner that the hydrophilic microfiber cloth is exposed and thus can dry faster after a cleaning process.

An exemplary embodiment of the invention, namely a pen-like device, is explained in more detail below with reference to the drawings.

In the figures:

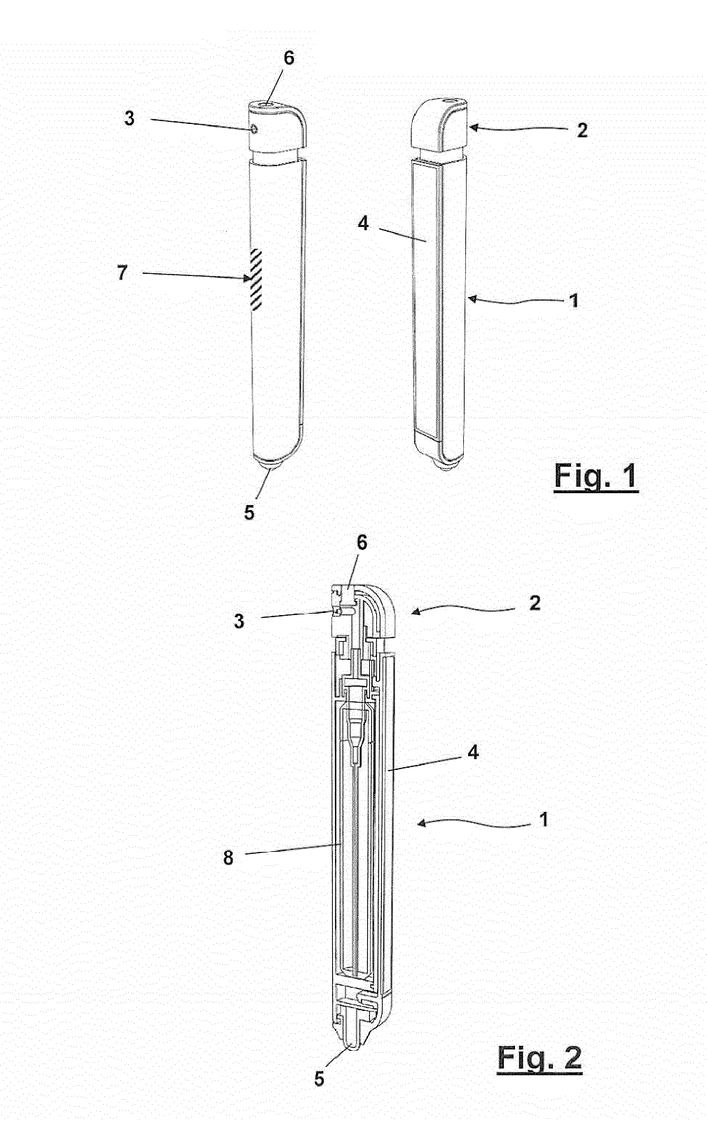

FIG. 1 shows a 3D view of the manual device from two sides,

FIG. 2 shows a 3D longitudinal section of the manual device,

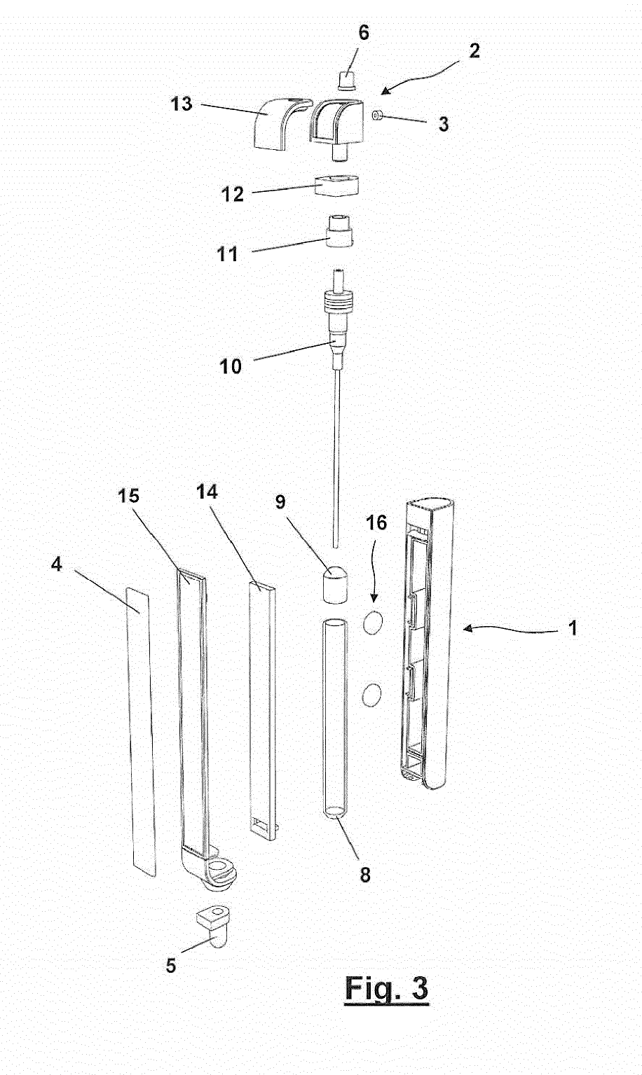

FIG. 3 shows a 3D exploded view of the manual device,

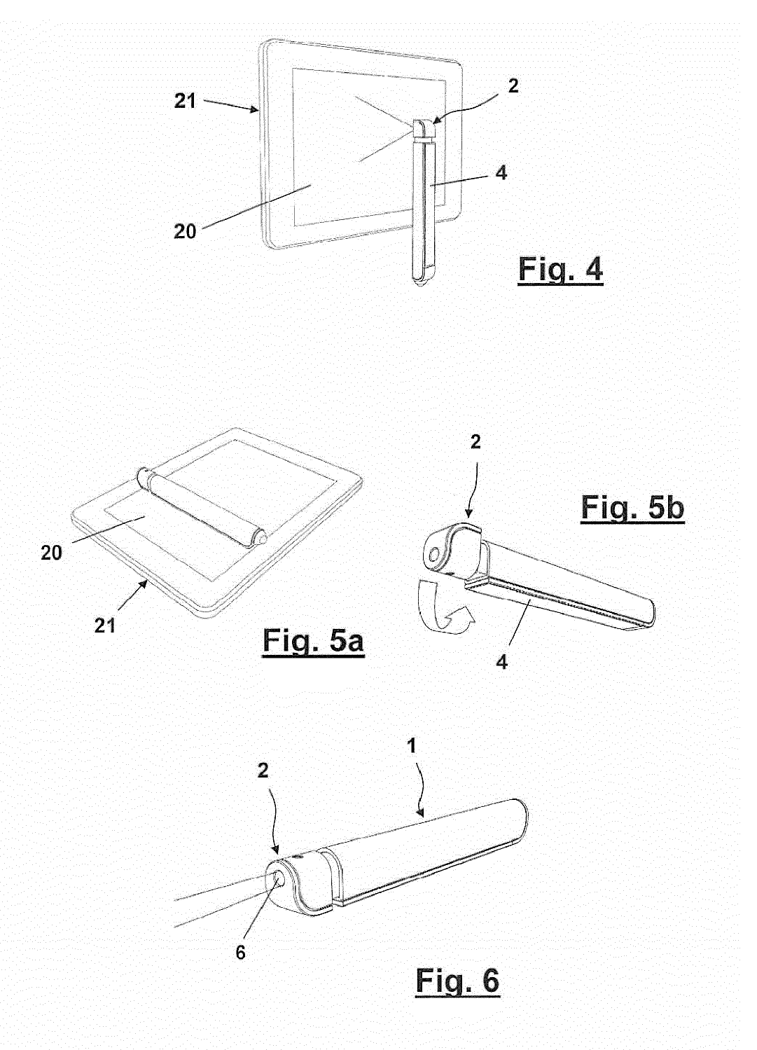

FIG. 4 shows the use of the manual device for spraying the cleaning fluid,

FIG. 5a shows the use of the manual device for cleaning a smooth and flat surface,

FIG. 5b shows the preparation of the manual device for facilitating the cleaning of corners of a rectangular surface,

FIG. 6 shows the use of the manual device as a laser pointer,

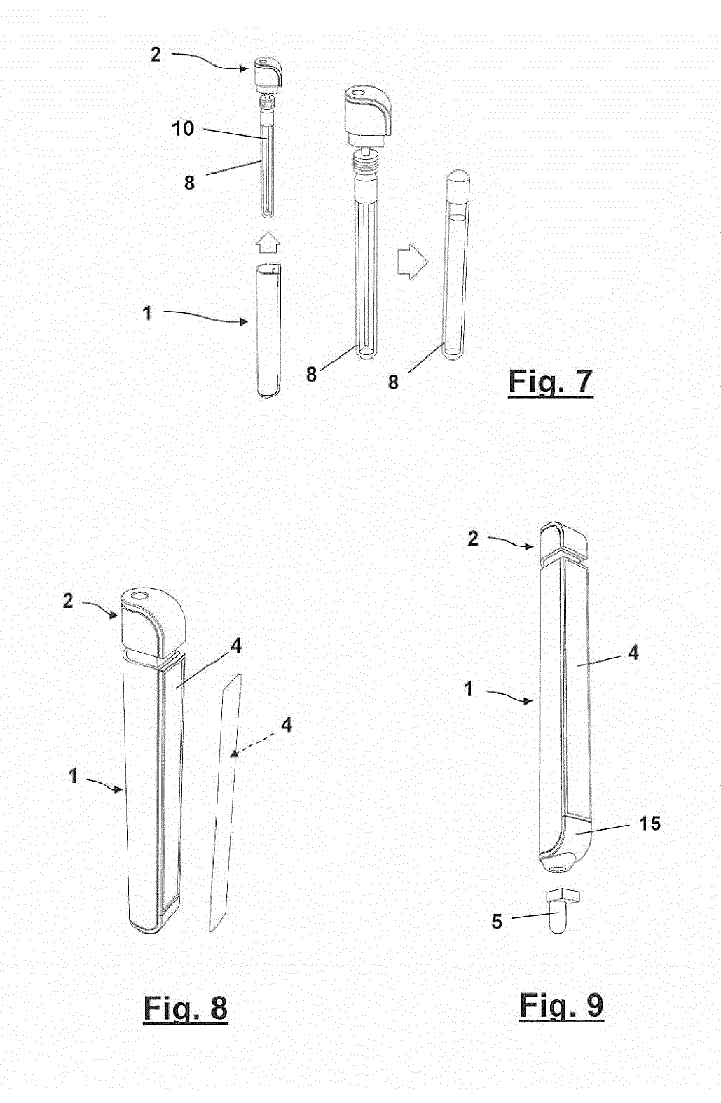

FIG. 7 shows the exchangeability of a cleaning fluid cartridge,

FIG. 8 shows the exchangeability of the microfiber cloth, and

FIG. 9 shows the exchangeability of the stylus tip.

FIG. 1 shows a 3D view of a manual device for cleaning surfaces from two sides, namely from laterally on the rear and from laterally on the front. The manual device has an elongated pen-like shape with a body 1 and an integrated spraying unit having a spray head 2. The spray head 2 is attached to the body 1 to be rotatable about a longitudinal axis and has a spraying nozzle 3 for spraying cleaning fluid. On a lateral surface of the body 1, a cleaning element is connected to the manual device. The cleaning element consists of a hydrophilic microfiber cloth 4 that has a flat cleaning surface and is arranged in the longitudinal direction of the pen-like shape. The microfiber cloth 4 is exchangeable, has an elongated rectangular shape and extends over almost the entire length of the body 1.

Furthermore, at the end of the pen-like shape, which end is opposite the spray head 2, the manual device has a pen tip 5 for use as a stylus for a touch-sensitive screen (touch screen). Moreover, a laser diode 6 for a laser pointer can be mounted in the spray head 2. A touch-sensitive contact surface 7 that can be situated in a lateral region of the pen-like shape for triggering the laser pointer function is not illustrated here. The individual components of the manual device for cleaning surfaces are explained hereafter in greater detail with reference to the FIGS. 2 and 3.

FIG. 2 shows a 3D longitudinal sectional view of the manual device, again from laterally on the rear. It can already be seen here that the manual device for cleaning surfaces is equipped with a cartridge 8 with cleaning fluid. The cartridge 8 is also exchangeable, as will be shown hereafter in more detail.

FIG. 3 shows a 3D exploded view of the manual device in which the individual components can be seen more clearly.

The cartridge 8 with the cleaning fluid has a cartridge cap 9. A pump unit 10 can be inserted into the cartridge 8. A closure unit 11 with a cover 12 can be attached onto the pump unit 10. Finally, the spray head 2 can be attached onto the closure unit 11 and the cover 12, wherein the spray head, on its part, contains the spraying nozzle 3 and the laser diode 6 for the laser pointer and is covered by a separate head cover 13.

The cartridge 8 with the cartridge cap 9, the pump unit 10, the closure unit 11 and the cover 12 can be inserted into the body 1 of the pen-like shape. They are retained therein by a cover plate 14. Finally, the whole arrangement is covered by a separate body cover 15 which can be snapped into place on the body 1 and into which, in turn, the pen tip 5 can also be inserted. The pen tip 5 is preferably selected such that it comprises an electrically conductive pigmentation having an electrical resistance >200Ω and that it is suitable specifically for touch screens of the resistive type.

On or in the body cover 15, the microfiber cloth 4 is attached or can be inserted. The microfiber cloth 4 has hydrophilic properties and contains a hydrophilic substance such as boron in order to be able to absorb or cross-link a larger portion of cleaning fluid. As mentioned at the beginning, other substances or additives can also be used for this purpose.

Also shown in FIG. 3 are magnets and batteries 16 which can be inserted into suitable recesses in the body 1.

FIG. 4 shows the use of the manual device for spraying the cleaning fluid. The spray head 2 is shown here in a rotational position in which the closure unit 11 is open and spraying the cleaning fluid can be triggered by pressing onto the spray head 2. In this manner, the touch screen 20 of an electronic device 21 can be sprayed and prepared for cleaning, for example.

FIG. 5a shows the use of the manual device for cleaning a smooth and flat surface, and as shown here, for cleaning the touch screen 20. For this, the surface of the microfiber cloth 4 is placed onto the surface of the touch screen 20, which is wetted with cleaning fluid, and the touch screen is cleaned by rubbing.

FIG. 5b shows the preparation of the manual device for facilitating the cleaning of corners of a rectangular surface, because the present construction with the rotatable spray head 2 makes it possible, of course, that the spray head can be temporarily turned away for better accessibility of the corners of the touch screen 20.

FIG. 6 shows the use of the manual device as a laser pointer, which is only indicated here during operation. Activation takes place, as mentioned earlier, with the touch-sensitive contact surface 7 on the longitudinal side of the pen-like shape.

FIG. 7 shows schematically the exchangeability of the cartridge 8 for the cleaning fluid. For this, the unit with the empty cartridge 8, the pump unit 10 and the spray head 2 is pulled out of the body 1 of the manual device, and the empty cartridge 8 is subsequently removed from the pump unit 10 and finally replaced.

FIG. 8 shows schematically the exchangeability of the microfiber cloth 4. It is not illustrated here that, depending on the construction, the body cover 15 has possibly first to be detached for this purpose.

FIG. 9 schematically shows the exchangeability of the pen tip 5. It is not illustrated here that first the body cover 15 has to be detached.

The above-described exemplary embodiment of the manual device has a pen-like shape. However, it is also provided that the manual device can also have a flat rectangular shape and thus is approximately comparable in terms of its outer shape to the shape of today's commonly used smart phones. Of course, in terms of the size, it can then be adapted to the size of the touch screens of the smartphones to be cleaned, or it can also be built slightly larger so that it is better suited for larger touch screens. While the pen-like shape is obviously better suited for additional functions such as styluses, this applies to the flat rectangular shapes to a lesser extent. However, for other additional functions such as, for instance, the mentioned laser pointer function, both embodiments appear to be equally suited.

### REFERENCE LIST

1 Body

2 Spray head

3 Spraying nozzle

4 Microfiber cloth

5 Pen tip

6 Laser diode

7 Contact surface

8 Cartridge

9 Cartridge cap

10 Pump unit

11 Closure unit

12 Cover

13 Head cover

14 Cover plate

15 Body cover

16 Magnets and/or batteries

17-19 not used

20 Touch screen

21 Electronics device

1. A manual device for cleaning surfaces, comprising an integrated spraying unit, wherein the manual device
can be operated with one hand,
has a reservoir for a cleaning fluid that can be sprayed using the spraying unit, and
a cleaning element in the form of a microfiber cloth that is suitable for wiping the surfaces to be cleaned,
characterized in that
the manual device has a pen-like or flat rectangular shape, that the microfiber cloth is hydrophilic, is connected to the manual device and is immovably arranged in the longitudinal direction thereof on the outer side and has a flat cleaning surface, and that the manual device is multifunctional and, in addition to the cleaning function, has at least one further function and means for the implementation thereof.

2. The manual device according to patent claim 1, characterized in that the at least one further function and means for the implementation thereof comprises an exchangeable pen tip (5) for operating touch-sensitive display devices (touch screens) and/or a laser pointer for use during presentations and lectures.

3. The manual device according to patent claim 1 or patent claim 2, characterized in that the flat cleaning surface has an elongated rectangular shape and that the microfiber cloth (4) is exchangeable.

4. The manual device having a pen-like shape according to any one of the patent claims 1 to 3, characterized in that a spray head (2) of the spraying unit is attached at an end of the pen-like shape to be pivotable about a longitudinal axis so as to be able to close the spraying unit, and that an exchangeable cartridge (8) for the cleaning fluid is provided.

5. The manual device according to patent claim 2, characterized in that the pen tip (5) for operating touch-sensitive display devices (touch screens) and the laser pointer are attached at opposite ends of the manual device.

6. The manual device according to any one of the patent claims 1 to 5, characterized in that the hydrophilic microfiber cloth (4) contains a hydrophilic substance having a boron content, a silver ion content or a content with nanoparticles in order to be able to absorb or cross-link a larger portion of cleaning fluid.

7. The manual device according to patent claim 2, characterized in that the pen tip (5) for operating touch-sensitive display devices (touch screens) comprises an electrically conductive pigmentation having an electrical resistance >200Ω.

8. The manual device according to patent claim 2, characterized in that a touch sensitive contact surface (7) for triggering the laser pointer function is provided in a lateral region of the pen-like shape.

9. The manual device according to any one of the patent claims 1 to 8, characterized in that a holding device is provided by means of which the manual device can be secured on another article or on a piece of clothing.
